(19) United States
(12) Patent Application Publication
(10) Pub. No.: US 2016/0067989 A1
(43) Pub. Date: Mar. 10, 2016

(54) IMAGE FORMATION APPARATUS AND IMAGE FORMATION METHOD

(71) Applicants: Shigeru Yoshigai, Kanagawa (JP); Yuuichiroh Tsujiguchi, Kanagawa (JP); Hitoshi Sasaki, Kanagawa (JP); Takuji Kawaguchi, Kanagawa (JP); Keizoh Shigaki, Kanagawa (JP)

(72) Inventors: Shigeru Yoshigai, Kanagawa (JP); Yuuichiroh Tsujiguchi, Kanagawa (JP); Hitoshi Sasaki, Kanagawa (JP); Takuji Kawaguchi, Kanagawa (JP); Keizoh Shigaki, Kanagawa (JP)

(73) Assignee: RICOH COMPANY, LTD., Tokyo (JP)

(21) Appl. No.: 14/848,225

(22) Filed: Sep. 8, 2015

(30) Foreign Application Priority Data
Sep. 10, 2014 (JP) 2014183980
Aug. 26, 2015 (JP) 2015166702

(51) Int. Cl. B41J 13/00

(52) U.S. Cl. CPC B41J 13/0009

(57) ABSTRACT

An image formation apparatus includes a conveying unit that conveys a recording medium; a recording head that reciprocates in a direction orthogonal to a conveying direction of the recording medium while the recording medium is being conveyed by the conveying unit, the recording head forming an image on the recording medium; a reception unit that receives scan image data, the scan image data being used to form the image, while the recording head waits in a non-printing region of the recording medium; and a control unit that controls a conveyance distance of the recording medium conveyed by the conveying unit while the recording head waits in the non-printing region. The control of the conveyance distance of the recording medium is determined based on a scan image data reception period of the scan image data, the scan image data reception period being obtained from a communication speed of the reception unit.

### CROSS-REFERENCE TO RELATED APPLICATIONS

The present application is based on and claims the benefit of priorities of Japanese Priority Application No. 2014-183980 filed on Sep. 10, 2014 and Japanese Priority Application No. 2015-166702 filed on Aug. 26, 2015, the entire contents of which are hereby incorporated by reference.

### BACKGROUND OF THE INVENTION

1. Field of the Invention

The present invention relates to an image formation apparatus and an image formation method.

2. Description of the Related Art

Inkjet recording apparatuses for forming an image are widely used. The inkjet recording apparatuses form an image by discharging ink onto a recording medium conveyed in a sub-scanning direction, the ink being discharged from a recording head reciprocating in a main-scanning direction orthogonal to the sub-scanning direction. In related inkjet recording apparatuses, an image is formed on a recording medium by repeating an operation in which the recording head performs scanning to form the image while conveyance of the recording medium is stopped, and the recording medium is conveyed to a predetermined amount while the recording head is slowing down or stopped.

In a configuration where image formation is performed by reciprocating the recording head to perform scanning while conveying the recording medium intermittently in this manner, a mechanical impact sound or the like caused by an operation to convey the recording medium or cause the recording head to perform scanning, especially when the operation starts or stops can be noisy.

In view of this, there are proposed printers that reduce an operation sound during image formation by regularly conveying the recording medium at a constant speed without stopping and by reducing an acceleration or deceleration time in reciprocation and scanning of the recording head when an image is formed (see Patent Document 1, for example).

### [Patent Document 1] Japanese Laid-Open Patent Application No. 2004-338215

### SUMMARY OF THE INVENTION

In a method for continuously conveying the recording medium at a constant speed in image formation, however, if reception of scan image data is delayed during the image formation, a shift may occur between an image formation operation and conveyance of the recording medium, so that an abnormal image may be formed.

The present invention has been made in view of the above-mentioned fact and it is a general object of at least one embodiment of the present invention to provide an image formation apparatus capable of performing accurate printing by preventing a shift between scanning of the recording head and conveyance of the recording medium.

In an embodiment, an image formation apparatus is provided. The image formation apparatus includes a conveying unit that conveys a recording medium; a recording head that reciprocates in a direction orthogonal to a conveying direction of the recording medium while the recording medium is being conveyed by the conveying unit, the recording head forming an image on the recording medium; a reception unit that receives scan image data, the scan image data being used to form the image, while the recording head waits in a non-printing region of the recording medium; and a control unit that controls a conveyance distance of the recording medium conveyed by the conveying unit while the recording head waits in the non-printing region. The control of the conveyance distance of the recording medium is determined based on a scan image data reception period of the scan image data, the scan image data reception period being obtained from a communication speed of the reception unit.

According to an embodiment, an image formation apparatus capable of performing accurate printing by preventing a shift between scanning of the recording head and conveyance of the recording medium will be provided.

### BRIEF DESCRIPTION OF THE DRAWINGS

Other objects and further features of embodiments will become apparent from the following detailed description when read in conjunction with the accompanying drawings, in which:

FIG. 1 is a schematic diagram showing a configuration of an inkjet recording apparatus according to a first embodiment;

FIG. 2 is a block diagram showing a configuration of an inkjet recording apparatus according to the first embodiment;

FIG. 3 is a diagram showing a print operation of an inkjet recording apparatus according to the first embodiment;

FIG. 4 is a diagram showing a carriage scanning speed and a paper conveying speed in the first embodiment;

FIG. 5A is a diagram showing how an image is being formed on paper in the first embodiment;

FIG. 5B is a diagram showing how an image is being formed on paper in the first embodiment;

FIG. 6 is a diagram showing an image formed on paper in the first embodiment;

FIG. 7 is a flowchart of a print process in the first embodiment;

FIG. 8 is a flowchart of a reception time calculation process in the first embodiment;

FIG. 9 is a flowchart of conveyance control process 1 in the first embodiment;

FIG. 10 is a diagram showing a control result of a conveying speed by conveyance control process 1 in the first embodiment;

FIG. 11 is a flowchart of conveyance control process 2 in the first embodiment;

FIG. 12 is a diagram showing a control result of a conveying speed by conveyance control process 2 in the first embodiment;

FIG. 13 is a flowchart of a print process in a second embodiment;

FIG. 14 is a flowchart of a maintenance process in the second embodiment;

FIG. 15 is a flowchart of a conveyance control process in the second embodiment;

FIG. 16 is a diagram showing color unevenness;

FIG. 17 is a flowchart of a print process in a third embodiment;

FIG. 18 is a diagram showing a print process (α=1) in the third embodiment; and

FIG. 19 is diagram showing a print process (α=3) in the third embodiment.

### DESCRIPTION OF THE PREFERRED EMBODIMENTS

In the following, an embodiment to carry out the invention will be described with reference to the drawings. In each of the drawings, the same constituent elements are given the same reference numerals and a redundant description may be omitted.

### First Embodiment

### Configuration of Inkjet Recording Apparatus

A configuration of an inkjet recording apparatus 1 according to a first embodiment is described. In the following description, the inkjet recording apparatus 1 forms an image on paper which serves as a recording medium in an example. However, the recording medium is not limited to paper but a film, cloth, or the like may be used.

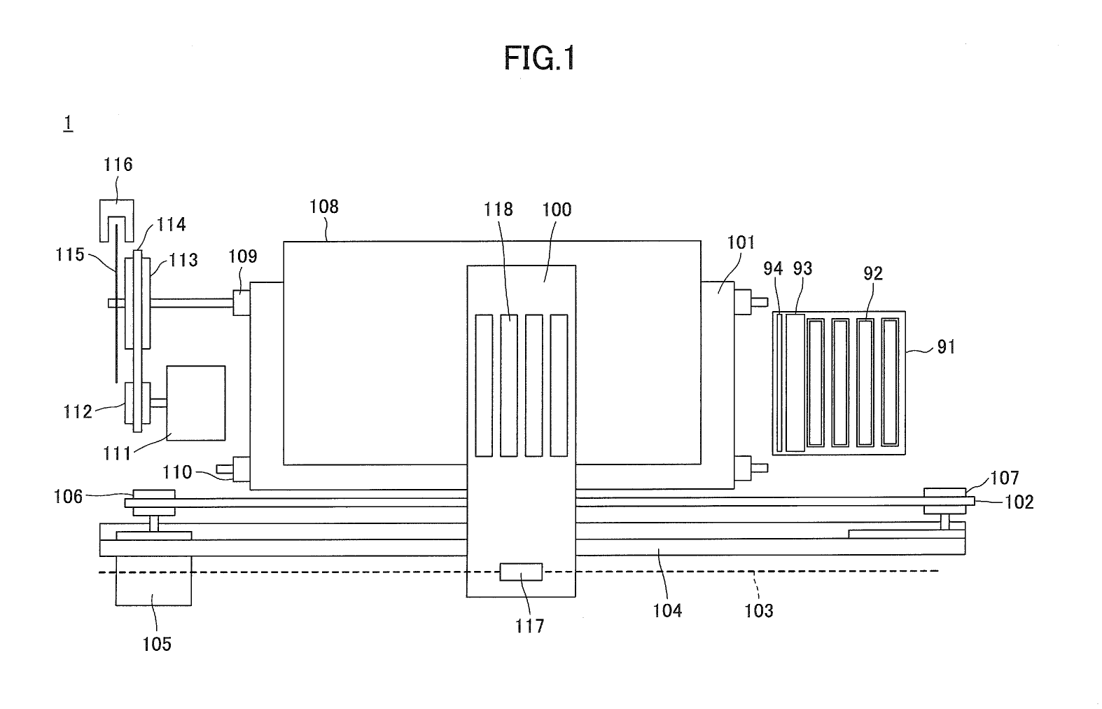

FIG. 1 is a schematic diagram showing a configuration of the inkjet recording apparatus 1 according to the first embodiment.

As shown in FIG. 1, the inkjet recording apparatus 1 according to the present embodiment includes a carriage 100 on which a recording head 118 for forming an image by discharging ink onto a paper 108 being conveyed is installed.

The carriage 100 is movably held in a main-scanning direction (right and left directions in FIG. 1) on a slide rail 104. Further, on the carriage 100, a part of a timing belt 102 stretched and installed between a driving pulley 106 and a driven pulley 107 disposed along the slide rail 104 is fixed, the timing belt 102 being rotated in accordance with the driving pulley 106.

When a main-scanning motor 105 connected to the driving pulley 106 starts driving, the timing belt 102 is rotated in accordance with the driving pulley 106 and the carriage 100 fixed on the timing belt 102 moves in the main-scanning direction along the slide rail 104.

On the carriage 100, a main-scanning encoder sensor 117 used to detect a position in the main-scanning direction is installed. The main-scanning encoder sensor 117 moves in the main-scanning direction together with the carriage 100 and detects a plurality of slits formed on an encoder scale 103. A position of the carriage 100 in the main-scanning direction is determined on the basis of a detection result of the slits on the encoder scale 103 by the main-scanning encoder sensor 117.

The recording head 118 installed on the carriage 100 includes four droplet discharge heads that discharge ink droplets of relevant colors such as yellow, cyan, magenta, and black. The recording head 118 is held on the carriage 100 such that a nozzle surface where a plurality of ink discharge ports (nozzles) of the droplet discharge heads are arranged faces a surface of the paper 108 to be conveyed. In addition, a number of droplet discharge heads, colors, and the like disposed on the recording head 118 are not limited to a configuration described in the present embodiment.

The recording head 118 discharges ink droplets from the droplet discharge heads while reciprocating in the main-scanning direction together with the carriage 100 in accordance with the above-mentioned configuration and forms an image in a printing region of the paper 108 conveyed in a sub-scanning direction orthogonal to the main-scanning direction.

The paper 108 is conveyed in the sub-scanning direction by a conveying belt 101. The conveying belt 101 is an endless belt stretched and installed between a conveying roller 109 and a tension roller 110 and rotated in the sub-scanning direction. The conveying belt 101 is charged by a charging roller (not shown) to electrostatically attract the paper 108 and conveys the paper 108 in the sub-scanning direction.

A timing belt 114 is stretched and installed between a conveying roller pulley 113 disposed on an end of a shaft of the conveying roller 109 and a conveyance driving pulley 112 connected to a sub-scanning motor 111. When the sub-scanning motor 111 starts rotational driving, the conveying roller 109 rotates via the conveyance driving pulley 112, the timing belt 114, and the conveying roller pulley 113, and the conveying belt 101 rotates in accordance with the conveying roller 109.

Further, on the end of the shaft of the conveying roller 109, an encoder wheel 115 having a plurality of slits formed at regular intervals in a circumferential direction is disposed. Further, a sub-scanning encoder sensor 116 that detects the slits of the encoder wheel 115 rotating together with the conveying roller 109 is fixedly disposed. A conveyance position of the paper 108 in the sub-scanning direction is determined from an amount of rotation of the conveying belt 101 obtained based on a detection result by the sub-scanning encoder sensor 116.

The conveying belt 101 and the sub-scanning motor 111 are an example of a conveying unit. The conveying belt 101 and the sub-scanning motor 111 convey the paper 108 fed from a paper feeding tray (not shown) and eject the paper 108 on which an image is formed from the apparatus.

Further, in a non-printing region on one side of the main-scanning direction of the carriage 100, a maintenance unit 91 for maintaining and restoring a nozzle state of the recording head 118 is disposed. The maintenance unit 91 includes a cap 92 that covers the nozzle surface of the recording head 118, an idle discharge receiver 93 that receives discharged liquid when the recording head 118 performs an idle discharge, and a wiper blade 94 that wipes off ink attached to the nozzle surface of the recording head 118.

A discharge failure resulting from a dried nozzle surface will be prevented when the carriage 100 not in use moves to the maintenance unit 91 and waits so that the nozzle surface of the recording head 118 is covered with the cap 92. Further, the carriage 100 moves to the maintenance unit 91 at predetermined maintenance time intervals, so that various types of maintenance processes such as an idle discharge of the recording head 118 and wiping of the nozzle surface of the recording head 118 are performed.

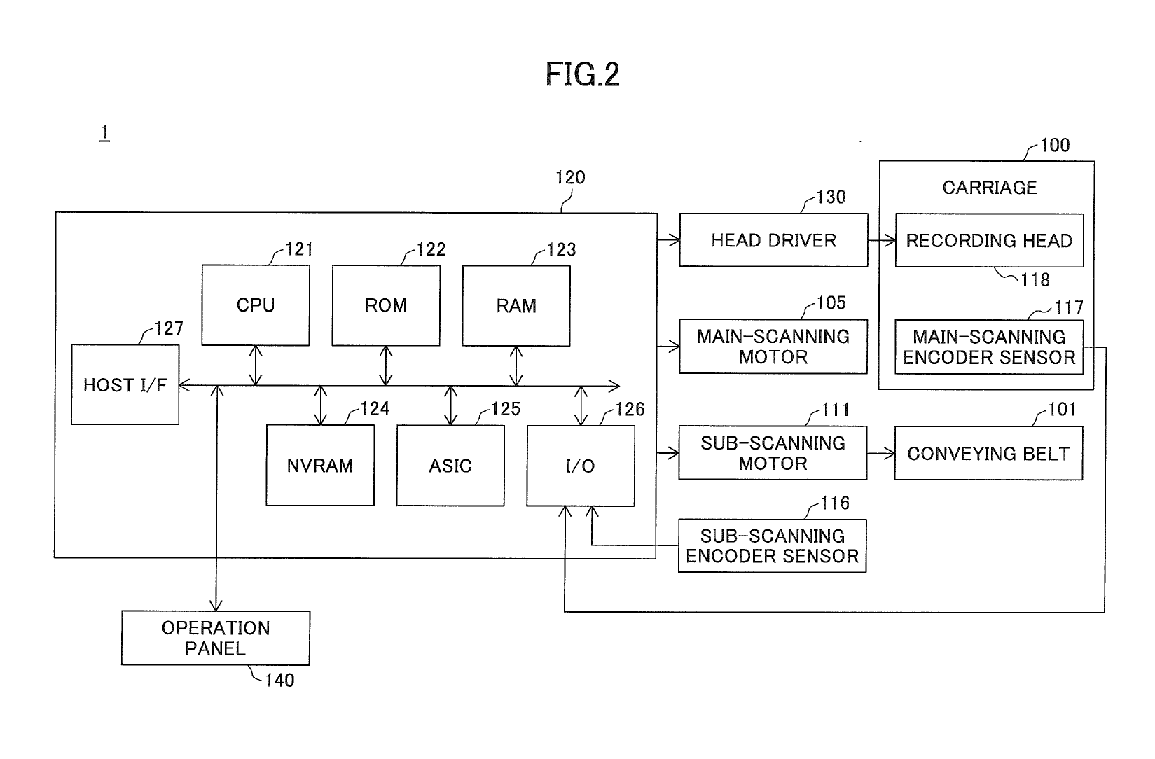

FIG. 2 is a block diagram showing a configuration of the inkjet recording apparatus 1 according to the embodiment.

As shown in FIG. 2, the inkjet recording apparatus 1 includes a control unit 120, a head driver 130, the carriage 100, the main-scanning motor 105, the sub-scanning motor 111, the conveying belt 101, the sub-scanning encoder sensor 116, and an operation panel 140.

The control unit 120 is an example of a control unit. The control unit 120 includes a CPU 121, a ROM 122, a RAM 123, an NVRAM 124, an ASIC 125, and an I/O 126. The control unit 120 controls each unit of the inkjet recording apparatus 1.

The ROM 122 stores various types of programs and data to be used by the programs. The RAM 123 is used as a storage area to load the programs and as a work area for the loaded programs. The CPU 121 implements various types of functions by executing the programs loaded into the RAM 123.

The ASIC 125 performs an image process such as various types of signal processes and arrangement for image data input to the inkjet recording apparatus 1 and processes other input and output signals for controlling the entire apparatus. The I/O 126 inputs and outputs signals between the main-scanning encoder sensor 117 and the sub-scanning encoder sensor 116. A host I/F 127 transmits and receives image data and various types of signals to and from an external device such as a personal computer (PC) connected to the inkjet recording apparatus 1 in a wired or wireless manner.

The control unit 120 performs an image process on image data input to the host I/F 127 and outputs image data subjected to the image process and driving waveforms to the head driver 130. The head driver 130 causes the recording head 118 to discharge ink by selectively applying driving pulses that constitute input driving waveforms to a pressure generation unit of the recording head 118.

When the main-scanning motor 105 is controlled by the control unit 120 to perform rotational driving, the main-scanning motor 105 causes the carriage 100 to move in the main-scanning direction together with the recording head 118. The main-scanning encoder sensor 117 moves in the main-scanning direction together with the carriage 100, detects the slits on the encoder scale 103, and outputs a detection signal to the I/O 126 of the control unit 120.

When the sub-scanning motor 111 is controlled by the control unit 120 to perform rotational driving, the sub-scanning motor 111 causes the conveying belt 101 to rotate and convey the paper 108. The sub-scanning encoder sensor 116 detects the slits of the encoder wheel 115 and outputs a detection signal to the I/O 126 of the control unit 120.

The operation panel 140 is hardware including an input unit such as buttons for receiving an input from a user and an operation screen such as a liquid crystal panel having a touch panel function. The operation panel 140 is connected to the control unit 120.

The inkjet recording apparatus 1 has the above-mentioned configuration, by which the control unit 120 controls scanning of the carriage 100 on which the recording head 118 is installed and conveyance of the paper 108, so that input image data is printed on the paper 108 and output.

### <Print Operation>

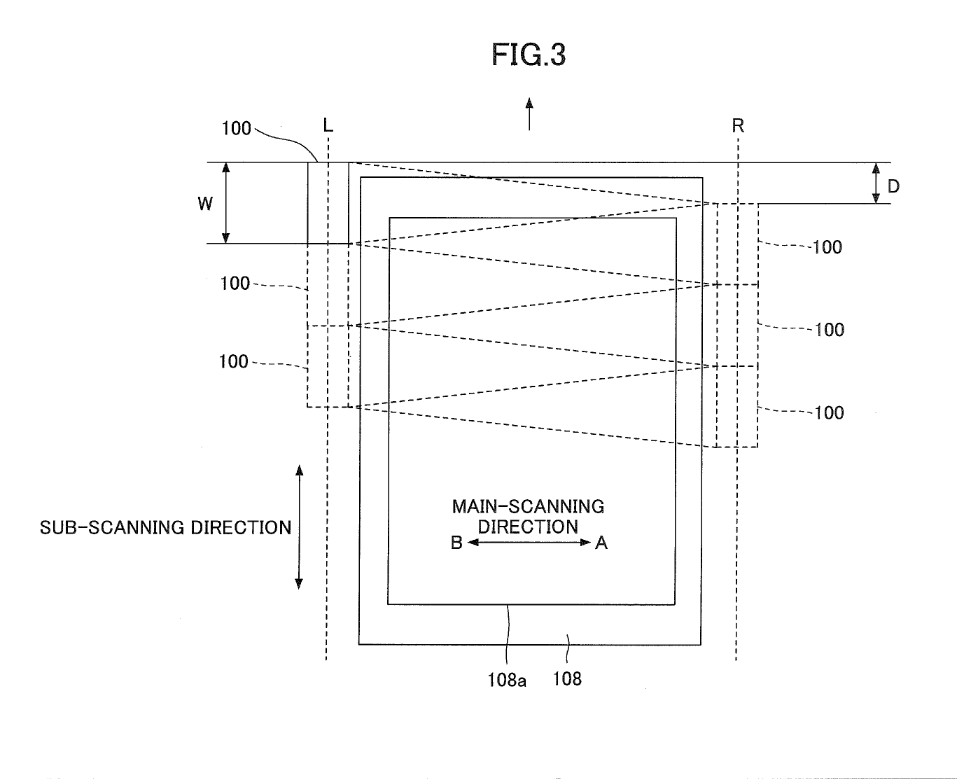

Next, a print operation in the inkjet recording apparatus 1 is described. FIG. 3 is a diagram illustrating a print operation in the inkjet recording apparatus 1.

In the inkjet recording apparatus 1, the paper 108 is conveyed in the sub-scanning direction (upward in FIG. 3) at a conveying speed controlled by the control unit 120. The carriage 100 reciprocates between a position L and a position R in the main-scanning direction, the position L and the position R functioning as positions to reverse a movement direction and being set in the non-printing region of the paper 108. The recording head 118 discharges ink droplets to form an image in a printing region 108a of the paper 108.

When the carriage 100 scans until the position L(R), for example, the carriage 100 temporarily stops. After next scan image data is input to the host I/F 127 of the control unit 120, the carriage 100 scans until the position R(L) and the recording head 118 forms an image based on the scan image data.

In the inkjet recording apparatus 1, the paper 108 is continuously conveyed in the sub-scanning direction without a stop during scanning of the carriage 100. Accordingly, as shown in FIG. 3, the carriage 100 moves in an oblique direction relative to the paper 108 being conveyed (direction inclining relative to both a conveying direction of the paper 108 and a direction orthogonal to the conveying direction).

The paper 108 is conveyed as much as a distance D less than ½ of a width W of a nozzle line in the sub-scanning direction, the nozzle line being disposed on the recording head 118, while the carriage 100 scans from the position L(R) to the position R(L) in the main-scanning direction. When the carriage 100 reciprocates in the main-scanning direction relative to the paper 108 being continuously conveyed in the sub-scanning direction in this manner, the recording head 118 scans the printing region 108a of the paper 108 without leaving any area to be scanned and forms an image.

In the inkjet recording apparatus 1, the paper 108 is continuously conveyed without a stop during scanning of the carriage 100 in this manner, so that a mechanical sound caused when an operation of the conveying belt 101 starts or stops is reduced in comparison with a case where the paper 108 is intermittently conveyed.

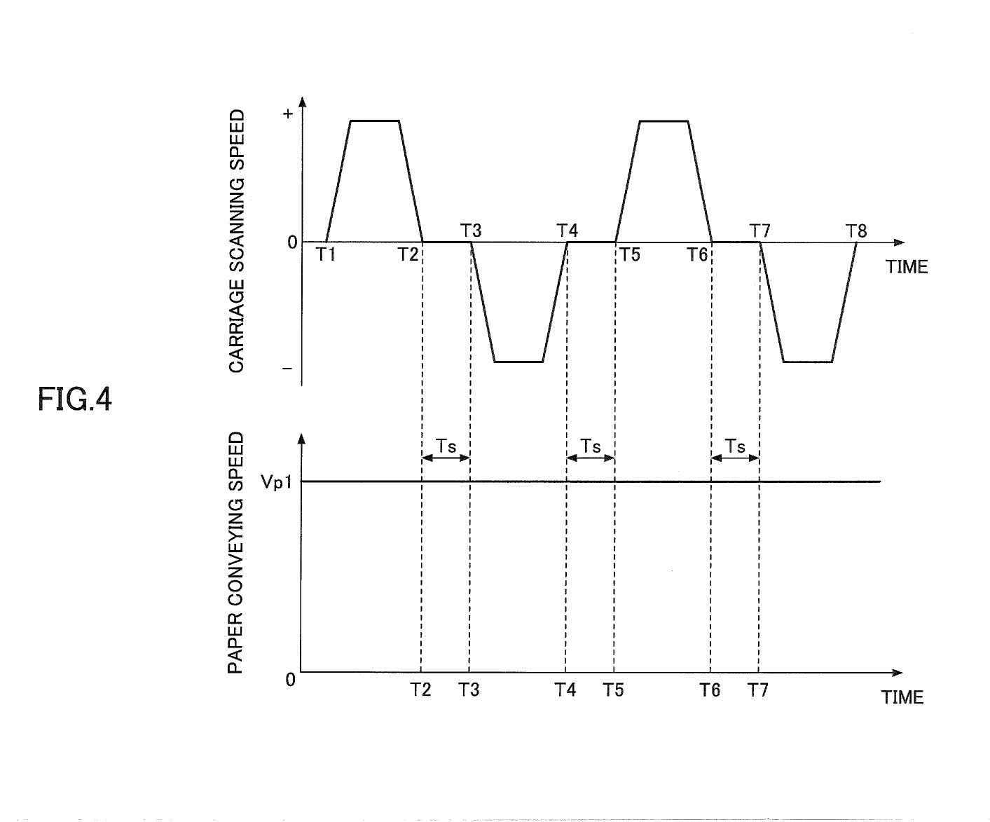

FIG. 4 is a diagram showing a scanning speed of the carriage 100 and a conveying speed of the paper 108 in the first embodiment. An upper graph in FIG. 4 shows the scanning speed of the carriage 100 where the scanning speed in a direction A shown in FIG. 3 is represented by a positive sign (+) and the scanning speed in a direction B shown in FIG. 3 is represented by a negative sign (−). Further, a lower graph in FIG. 4 shows the conveying speed of the paper 108.

As shown in the upper graph in FIG. 4, the carriage 100, when scan image data is input, starts scanning at a time T1 from the position L toward the position R and reaches the position R at a time T2. Further, as shown in the lower graph in FIG. 4, the paper 108 is conveyed in the sub-scanning direction at a conveying speed Vp1.

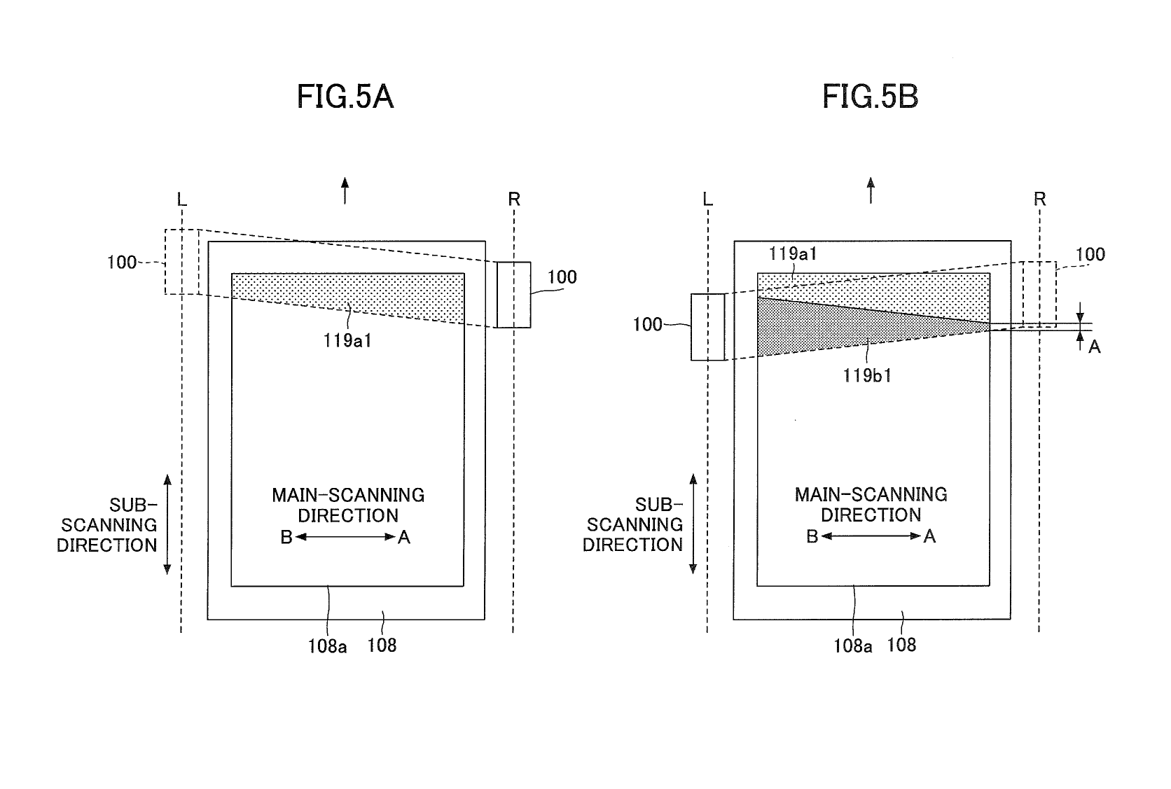

When the carriage 100 scans the paper 108 from the position L to the position R in the main-scanning direction in this manner, the paper 108 is being conveyed in the sub-scanning direction, so that an image is formed in a region 119a1 of the printing region 108a where the recording head 118 passes by as shown in FIG. 5A.

Next, as shown in FIG. 4, when the carriage 100 temporarily stops at the position R and next scan image data is input until a time T3, the carriage 100 reverses its movement direction and scans toward the position L. The carriage 100 reaches the position L at a time T4. While the carriage 100 temporarily stops from the time T2 to the time T3 and while the carriage 100 scans from the time T3 to the time T4, the paper 108 is conveyed in the sub-scanning direction at the conveying speed Vp1.

When the carriage 100 scans the paper 108 from the position R to the position L in the main-scanning direction in this manner, the paper 108 is being continuously conveyed in the sub-scanning direction, so that an image is formed in a region 119b1 of the printing region 108a where the recording head 118 passes by as shown in FIG. 5B.

In this case, as shown in FIG. 5B, during a waiting time Is from the time T2 to the time T3 when the carriage 100 and the recording head 118 reverse their movement direction in the non-printing region, the paper 108 is conveyed in the sub-scanning direction at the conveying speed Vp1, so that the paper 108 is displaced as much as a distance A(=Vp1×Ts). When the paper 108 is conveyed while the carriage 100 reverses its movement direction, an image formation position of the recording head 118 is also displaced as much as the distance A.

Subsequently, as shown in FIG. 4, when the carriage 100 temporarily stops at the position L and next scan image data is input from the time T4 to a time T5, the carriage 100 reverses its movement direction and scans toward the position R. The carriage 100 reaches the position R at a time T6 and temporarily stops until a time T7. When next scan image data is input from the time T6 to the time T7, the carriage 100 reverses its movement direction at the position R and scans towards the position L. The carriage 100 reaches the position L at a time T8. While the carriage 100 reciprocates and scans, the paper 108 is continuously conveyed in the sub-scanning direction at the conveying speed Vp1.

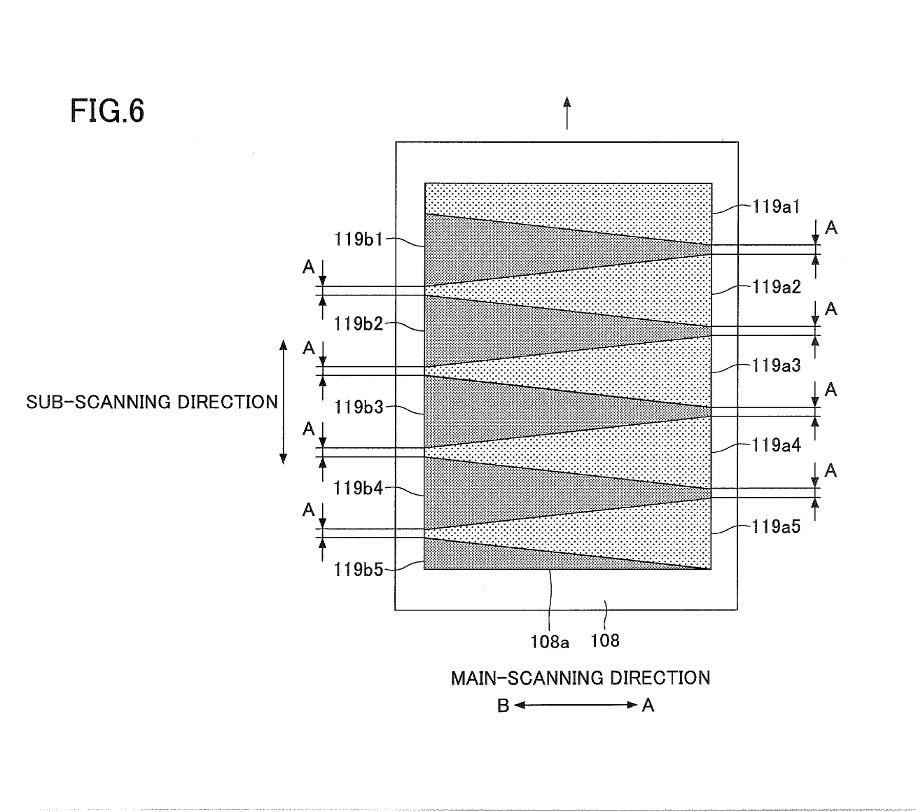

When the carriage 100 reciprocates and scans as mentioned above, images are successively formed on the paper 108 in the region 119a1, the region 119b1, a region 119a2, a region 119b2 . . . , so that an image is formed in an entire area of the printing region 108a as shown in FIG. 6.

If there is a delay of reception of the next scan image data while the carriage 100 reverses its movement direction at the position L or the position R, the carriage 100 will wait at the position L or the position R over a predetermined waiting time until the reception of the scan image data is complete. In such a case, when the paper 108 is continuously conveyed at the constant conveying speed Vp1, the distance A shown in FIGS. 5B and 6 becomes larger, so that a shift may occur at a scanning position of the recording head 118 and there may be an area where an image is not printed on the printing region 108a of the paper 108.

In view of this, if there is a delay of reception of the scan image data, the inkjet recording apparatus 1 according to the present embodiment is capable of printing on the entire area of the printing region 108a by changing the conveying speed of the paper 108 in accordance with a print process described below.

### <Print Process>

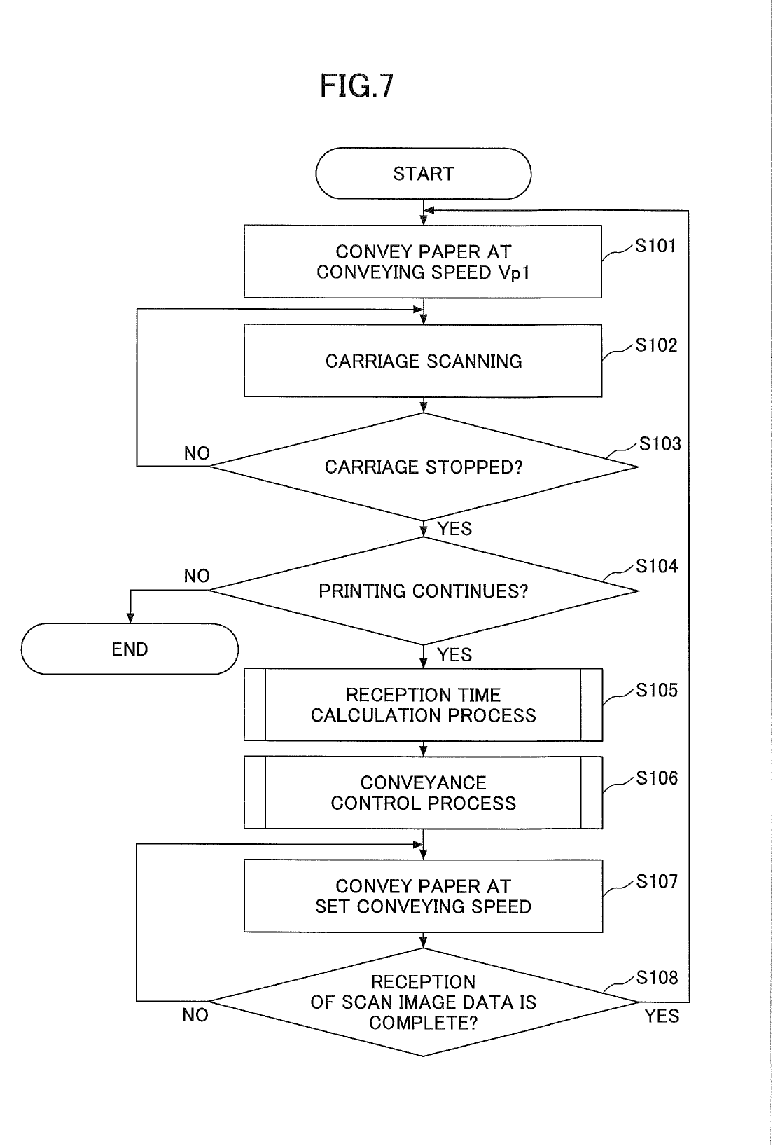

FIG. 7 is a flowchart of a print process in the first embodiment.

As shown in FIG. 7, when the inkjet recording apparatus 1 starts printing, in step S101, the paper 108 begins to be conveyed at the conveying speed Vp1. Next, in step S102, the carriage 100 and the recording head 118 scan in the main-scanning direction and form an image on the paper 108.

The carriage 100 scans toward one end of the main-scanning direction and stops at the position L or the position R shown in FIG. 3 (step S103: YES). If the printing is to be continuously performed (step S104: YES), a reception time calculation process is performed in step S105.

### (Reception Time Calculation Process)

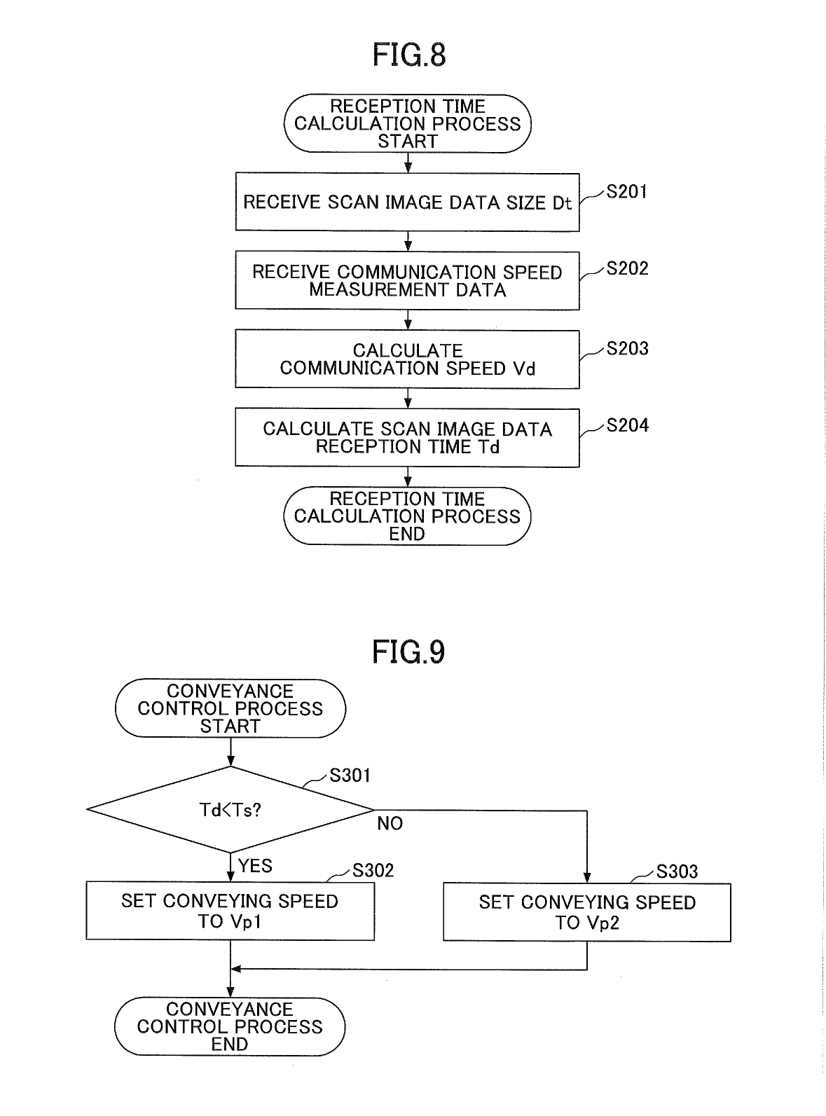

FIG. 8 is a flowchart of a reception time calculation process in the first embodiment.

In the reception time calculation process, first, in step S201, the host I/F 127 of the control unit 120 receives a size Dt of scan image data from a printer driver of a PC connected to the inkjet recording apparatus 1, for example. Next, in step S202, the host I/F 127 of the control unit 120 receives communication speed measurement data whose data size Ds is predetermined from the printer driver of the PC in the same manner.

In step S203, based on the following equation (1), the control unit 120 calculates a communication speed Vd between the inkjet recording apparatus 1 and the PC connected to the inkjet recording apparatus 1 using a reception time Tt of the communication speed measurement data.

Vd=Ds/Tt (1)

Next, in step S204, based on the following equation (2), the control unit 120 calculates a time Td required to receive the scan image data using the scan image data size Dt and the communication speed Vd.

Td=Dt/Vd (2)

As mentioned above, in the reception time calculation process, the control unit 120 calculates the reception time of the scan image data.

Returning to the flowchart of FIG. 7, when the reception time Td of the scan image data is obtained by the reception time calculation process in step S105, the control unit 120 performs a conveyance control process in step S106.

### (Conveyance Control Process 1)

FIG. 9 is a flowchart of a conveyance control process 1 in the first embodiment.

In the conveyance control process 1, as shown in FIG. 9, first, in step S301, the control unit 120 compares the reception time Td of the scan image data with a waiting time Is of the carriage 100 in the position L or the position R, the waiting time Ts being set in advance.

If the reception time Td is less than the waiting time Is (step S301: YES), in step S302, the control unit 120 sets the conveying speed of the paper 108 while the carriage 100 reverses its movement direction to the same conveying speed Vp1 as in printing (scanning of the carriage 100).

If the reception time Td is not less than the waiting time Is (S301: NO), in step S303, the control unit 120 sets the conveying speed of the paper 108 while the carriage 100 reverses its movement direction to a conveying speed Vp2 expressed by the following equation (3).

Vp2=Vp1×Ts/Td (3)

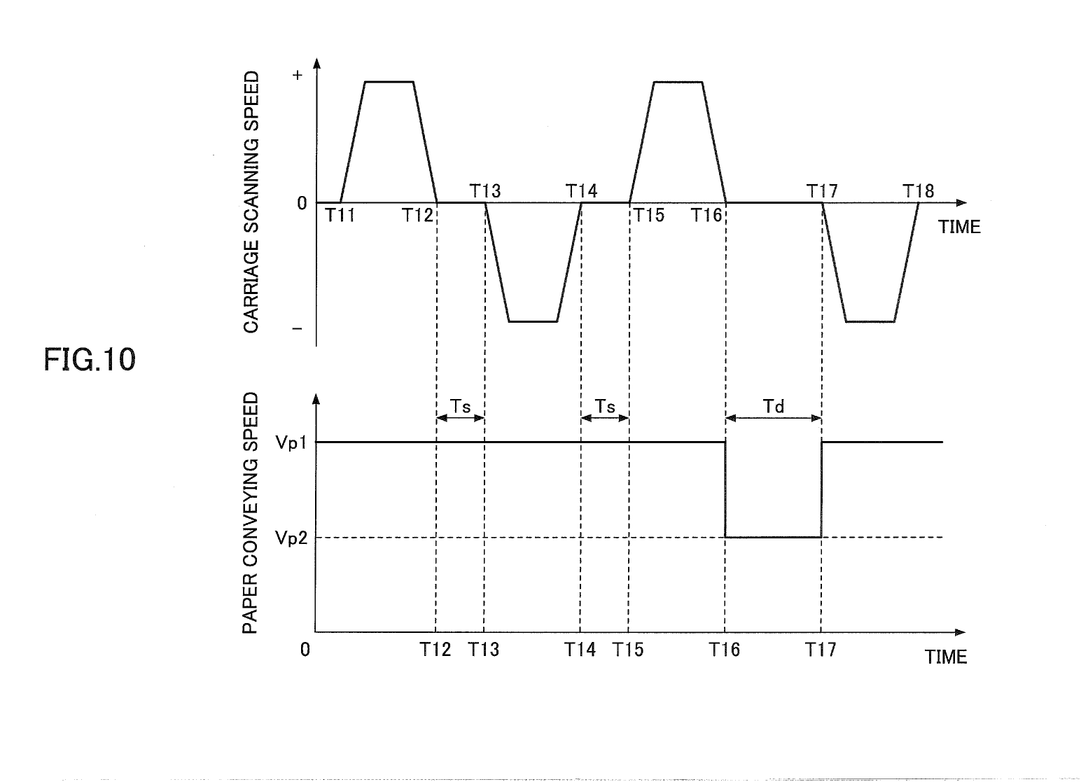

As shown in FIG. 10, it is assumed that the carriage 100 starts reciprocating and scanning from a time T11 and while the carriage 100 is printing on the paper 108 being conveyed at the conveying speed Vp1, the reception time Td of the scan image data is more than the predetermined waiting time Is at a time T16, for example.

In this case, the carriage 100 waits in the position R from the time T16 to a time T17 when the reception time Td has elapsed and reception of the scan image data is complete. From the time T16 to the time T17, the paper 108 is conveyed at the conveying speed Vp2 expressed by the equation (3).

In this case, a conveyance distance A of the paper 108 from a time T12 to a time T13 and from a time T14 to a time T15 is expressed by the following equation (4).

A=Vp1×Ts (4)

Further, a conveyance distance A′ of the paper 108 from the time T16 to the time T17 during which reception of the scan image data is delayed is expressed by the following equation (5).

A′=Vp2×Td (5)

In this case, the equation (5) is expressed as follows with the use of the equation (3).

$${A}^{′} = ( Vp 1 \times Ts / Td ) \times Td = Vp 1 \times Ts = A$$

In this manner, the conveyance distance A′ of the paper 108 from the time T16 to the time T17 during which reception of the scan image data is delayed is equal to the conveyance distance A of the paper 108 from the time T12 to the time T13 and from the time T14 to the time T15.

Accordingly, even if the reception time Td of the scan image data becomes not less than the predetermined waiting time Ts, the conveyance distance of the paper 108 while the carriage 100 and the recording head 118 reverse their movement direction is constantly maintained, so that it is possible to accurately form an image on the paper 108.

### (Conveyance Control Process 2)

Further, the conveying speed of the paper 108 while the carriage 100 reverses its movement direction may be controlled by a conveyance control process 2 below.

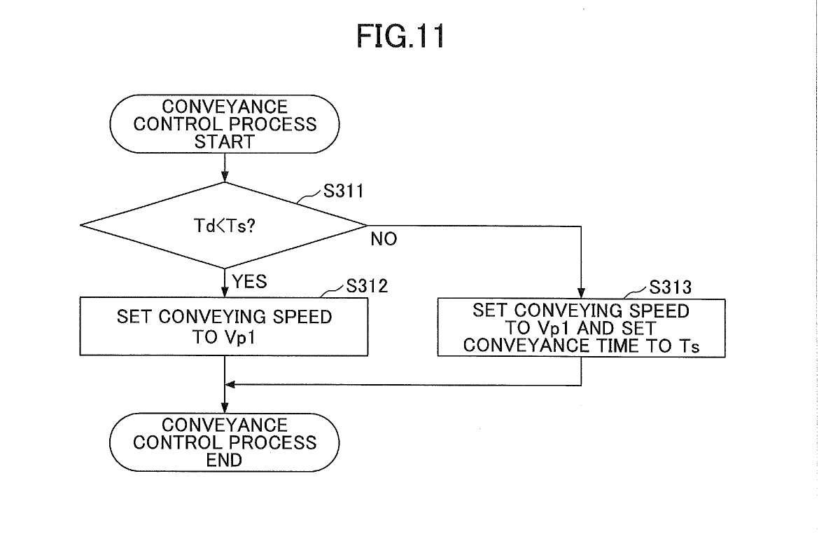

FIG. 11 is a flowchart of the conveyance control process 2 in the first embodiment.

In the conveyance control process 2, as shown in FIG. 11, first, in step S311, the control unit 120 compares the reception time Td of the scan image data with the waiting time Is of the carriage 100 in the position L or the position R, the waiting time Is being set in advance.

If the reception time Td is less than the waiting time Is (step S311: YES), in step S312, the control unit 120 sets the conveying speed of the paper 108 while the carriage 100 reverses its movement direction to the same conveying speed Vp1 as in printing (scanning of the carriage 100).

If the reception time Td is not less than the waiting time Is (S311: NO), in step S313, the control unit 120 sets the conveying speed and a conveyance time of the paper 108 while the carriage 100 reverses its movement direction to the conveying speed Vp1 and the waiting time Ts, respectively.

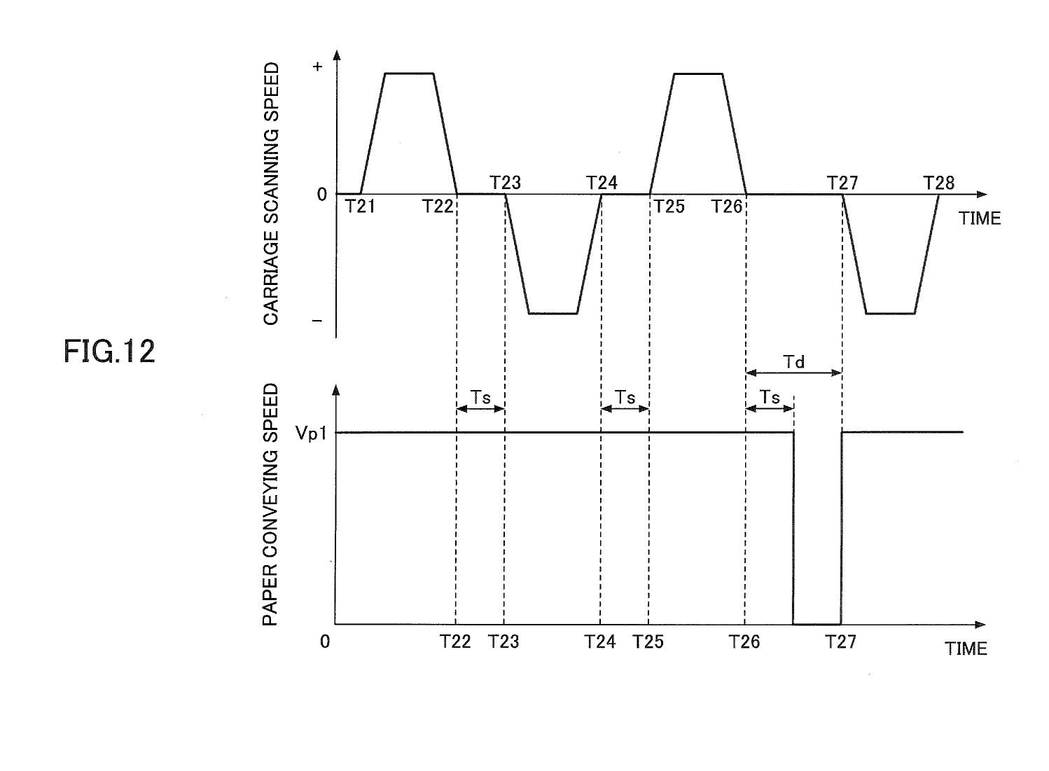

As shown in FIG. 12, it is assumed that the carriage 100 starts reciprocating and scanning from a time T21 and while the carriage 100 is printing on the paper 108 being conveyed at the conveying speed Vp1, the reception time Td of the scan image data is more than the predetermined waiting time Is at a time T26, for example.

In this case, the carriage 100 waits in the position R until a time T27 during which the reception time Td has elapsed and reception of the scan image data is complete. The paper 108 is continuously conveyed at the conveying speed Vp1 from the time T26 until the waiting time Ts has elapsed and then the conveyance is stopped when the waiting time Ts has elapsed.

In accordance with the above-mentioned control, the conveyance distance A′ of the paper 108 from the time T26 to the time T27 during which reception of the scan image data is delayed is equal to the conveyance distance A of the paper 108 from a time T22 to a time T23 and from a time T24 to a time T25.

Accordingly, even if the reception time Td of the scan image data becomes not less than the predetermined waiting time Ts, the conveyance distance of the paper 108 while the carriage 100 and the recording head 118 reverse their movement direction is constantly maintained, so that it is possible to accurately form an image on the paper 108.

In addition, as long as the conveyance distance of the paper 108 while the carriage 100 and the recording head 118 reverse their movement direction can be constantly maintained, both of the conveying speed and the conveyance time of the paper 108 may be changed by the control.

Returning to the flowchart of FIG. 7, when the conveying speed of the paper 108 is set by the conveyance control process in step S106, the paper 108 is conveyed at the set conveying speed while the carriage 100 is stopped in step S107.

In step S108, when the reception time Td of the scan image data has elapsed and the reception of the scan image data by the host I/F 127 of the control unit 120 is complete, the process from step S101 is performed again.

As mentioned above, in the inkjet recording apparatus 1 according to the first embodiment, even if the reception of the scan image data is delayed, the conveyance distance of the paper 108 while the carriage 100 and the recording head 118 reverse its movement direction is constantly maintained. Accordingly, the inkjet recording apparatus 1 accurately forms an image on the paper 108 by preventing a shift between scanning of the recording head 118 and conveyance of the paper 108.

### Second Embodiment

Next, a second embodiment is described based on the drawings. A description of the same constituent elements as in the above-mentioned embodiment is omitted.

In the inkjet recording apparatus 1 according to the second embodiment, the conveying speed of the paper 108 while the carriage 100 and the recording head 118 reverse their movement direction is controlled in accordance with the reception time of the scan image data or a maintenance time for the recording head 118.

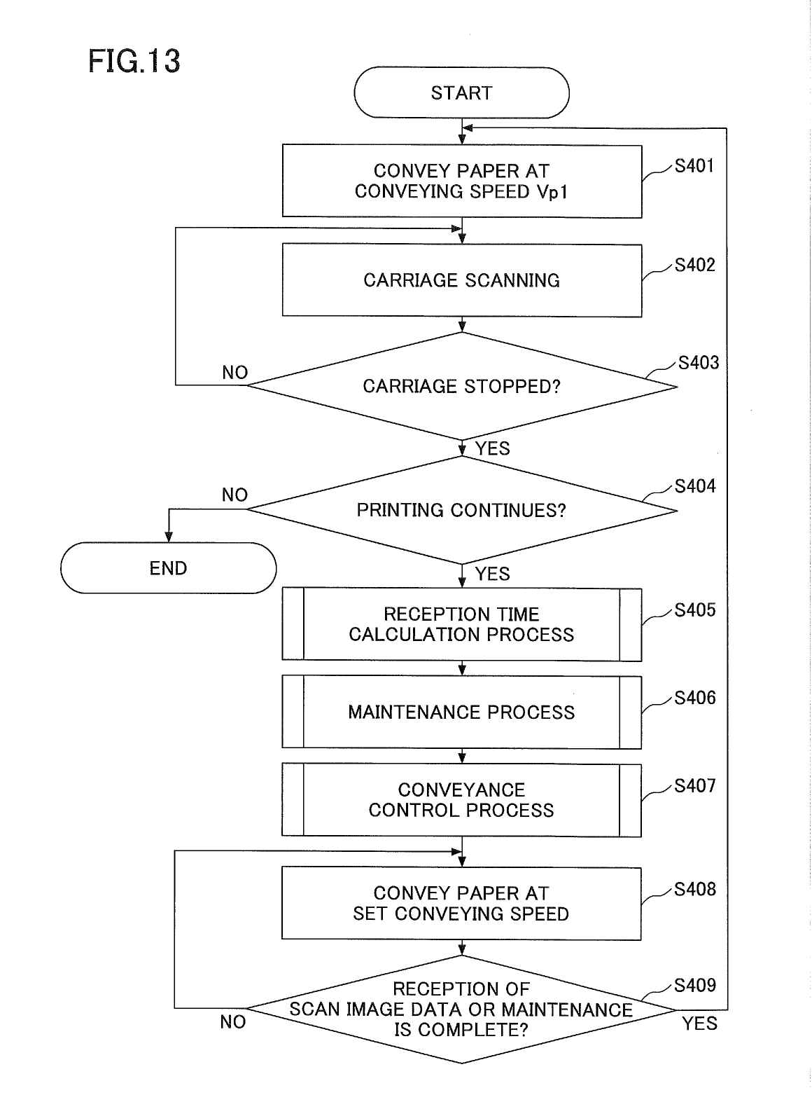

FIG. 13 is a flowchart of a print process in the second embodiment.

As shown in FIG. 13, when printing starts in the inkjet recording apparatus 1, in step S401, the paper 108 starts being conveyed at the conveying speed Vp1. Next, in step S402, the carriage 100 scans in the main-scanning direction and the recording head 118 forms an image on the paper 108.

The carriage 100 scans toward one end of the main-scanning direction and stops at the position L or the position R shown in FIG. 3 (step S403: YES). If the printing is to be continuously performed (step S404: YES), a reception time calculation process is performed in step S405.

When the reception time Td of the scan image data is obtained in the reception time calculation process, the control unit 120 performs a maintenance process in step S406.

### (Maintenance Process)

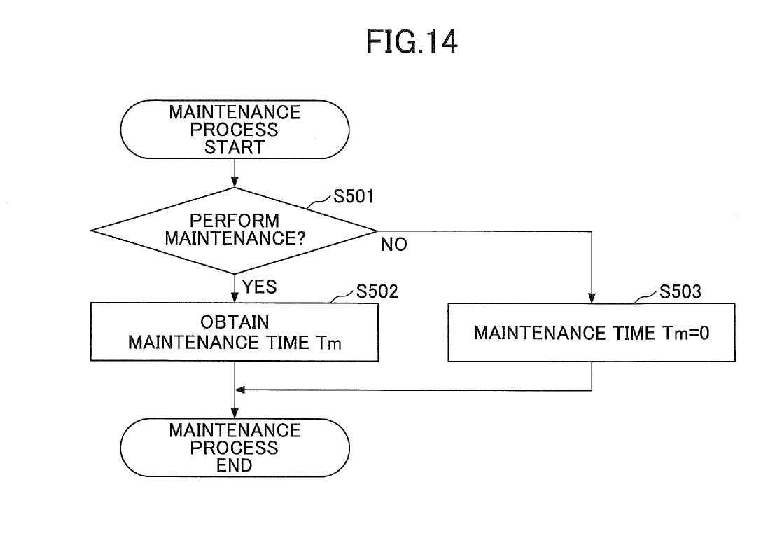

FIG. 14 is a flowchart of the maintenance process in the second embodiment.

In the maintenance process, first, in step S501, the control unit 120 confirms whether to perform maintenance of the recording head 118. Maintenance such as an idle discharge and wiping of the recording head 118 is performed at predetermined maintenance time intervals determined in advance for each maintenance type, for example.

If the maintenance is to be performed (step S501: YES), in step S502, the control unit 120 obtains a maintenance time Tm. The ROM 122, the RAM 123, and the NVRAM 124 of the control unit 120 are examples of a storage unit. A maintenance type and the maintenance time Tm for each maintenance type of the recording head 118 are stored in any of them.

Examples of the maintenance type include an idle discharge of the recording head 118 and wiping of the nozzle surface of the recording head 118. When maintenance is performed, the carriage 100 moves to the maintenance unit 91 where various types of maintenance are performed.

If maintenance is not to be performed (step S501: NO), in step S503, the control unit 120 sets the maintenance time Tm to zero. If maintenance is not to be performed, the carriage 100 waits at the positions to reverse its movement direction (position L or position R shown in FIG. 3) in the non-printing region.

Returning to the flowchart in FIG. 13, when the control unit 120 obtains the maintenance time Tm, the control unit 120 performs a conveyance control process in step S407.

### (Conveyance Control Process)

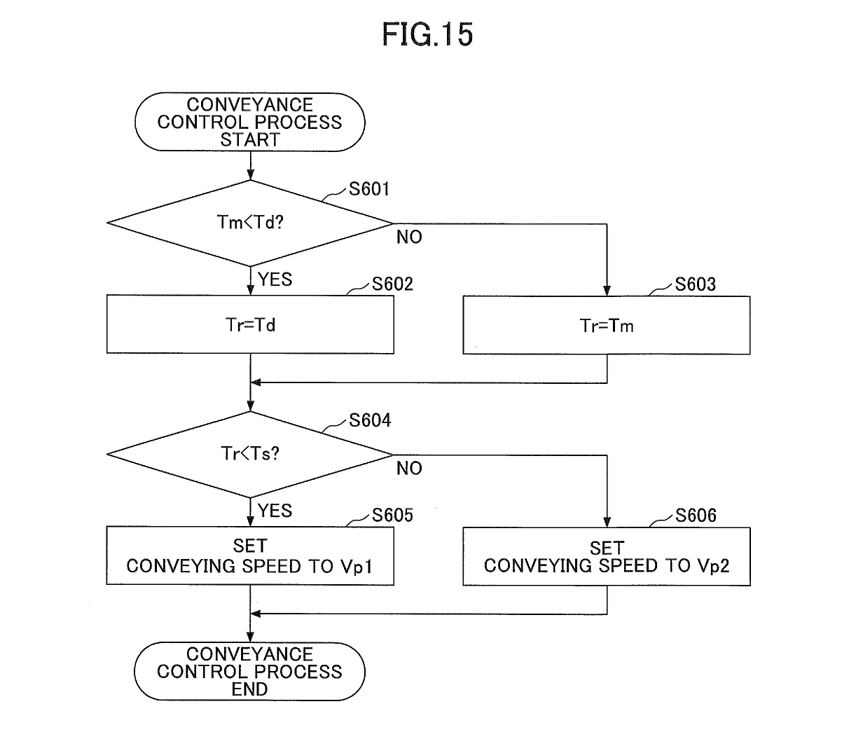

FIG. 15 is a flowchart of the conveyance control process in the second embodiment.

In the conveyance control process, as shown in FIG. 15, first, in step S601, the control unit 120 compares the reception time Td of the scan image data calculated in the reception time calculation process with the maintenance time Tm obtained in the maintenance process.

If the reception time Td is more than the maintenance time Tm (step S601: YES), in step S602, a process time Tr necessary for the process of the carriage 100 in the non-printing region is set to the reception time Td. Further, if the reception time Td is not more than the maintenance time Tm (step S601: NO), in step S603, the process time Tr is set to the maintenance time Tm.

Next, in step S604, the control unit 120 compares the process time Tr with the waiting time Ts of the carriage 100 at the position L or the position R, the waiting time Ts being set in advance.

If the process time Tr is less than the waiting time Ts (step S604: YES), in step S605, the control unit 120 sets the conveying speed of the paper 108 while the carriage 100 reverses its movement direction to the same conveying speed Vp1 as in printing (scanning of the carriage 100).

If the process time Tr is not less than the waiting time Ts (step S604: NO), in step S606, the control unit 120 sets the conveying speed of the paper 108 at the process time Tr while the carriage 100 reverses its movement direction to the conveying speed Vp2 expressed by the following equation (6).

Vp2=Vp1×Ts/Tr (6)

In accordance with the above-mentioned conveyance control process, the conveying speed of the paper 108 is controlled such that the conveyance distance of the paper 108 while the carriage 100 and the recording head 118 reverse their movement direction is constantly maintained. Accordingly, the recording head 118 is capable or accurately forming an image on the paper 108.

In addition, in the above-mentioned conveyance control process, the conveying speed of the paper 108 while the carriage 100 reverses its movement direction is changed. However, as long as the conveyance distance of the paper 108 while the carriage 100 reverses its movement direction can be constantly maintained, the conveyance time of the paper 108 may be changed or both of the conveying speed and the conveyance time of the paper 108 may be changed by the control.

Returning to the flowchart in FIG. 13, in step S407, when the conveying speed of the paper 108 is set in the conveyance control process, in step S408, the paper 108 is conveyed at the conveying speed that has been set while the carriage 100 stops at the positions to reverse its movement direction in the maintenance unit 91.

In step S409, if the reception of the scan image data is complete or the maintenance of the recording head 118 is complete, the process from step S401 is performed again.

As described above, in the inkjet recording apparatus 1 according to the second embodiment, even if the maintenance of the recording head 118 is performed, the conveyance distance of the paper 108 while the carriage 100 and the recording head 118 reverse their movement directions in the non-printing region is constantly maintained. Accordingly, the inkjet recording apparatus 1 according to the second embodiment accurately forms an image on the paper 108 by preventing a shift between scanning of the carriage 100 and conveyance of the paper 108.

### Third Embodiment

Next, a third embodiment is described based on the drawings. A description of the same constituent elements as in the above-mentioned embodiment is omitted.

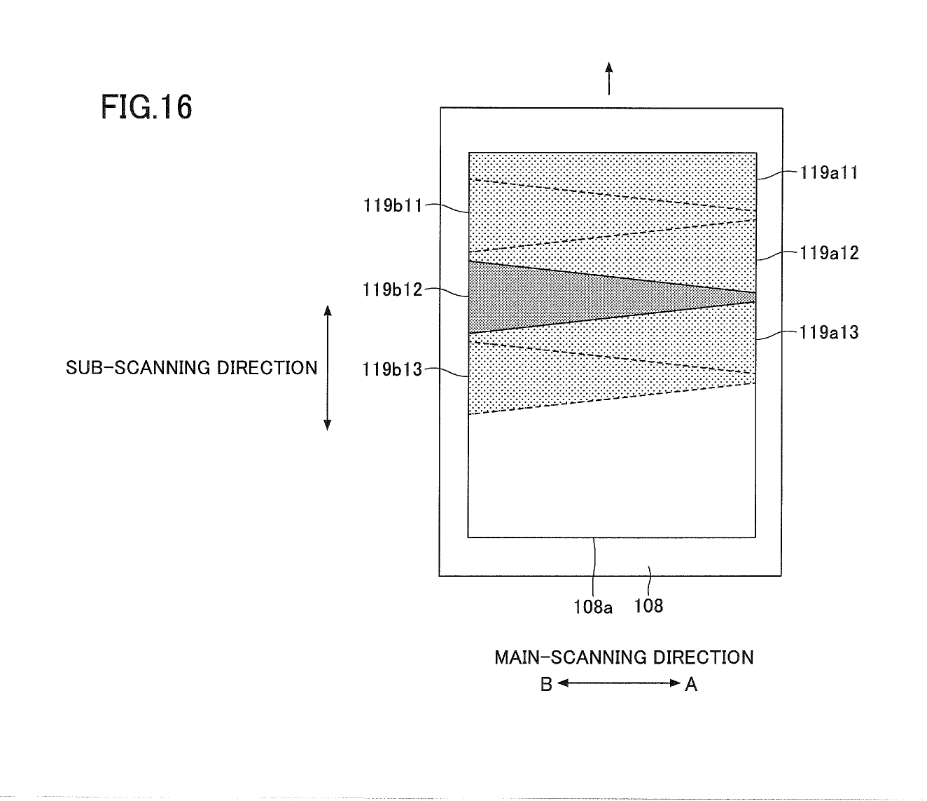

In the above-mentioned inkjet recording apparatus 1, if reception of the scan image data is delayed and the carriage 100 is caused to wait in the non-printing region until the reception of the scan image data is complete, there is a difference of a degree of ink dryness on a printed area when scanning starts due to a change of the waiting time. If an image is formed by overlaying ink on ink having a different degree of ink dryness in this manner, color unevenness may be generated in the image formed on the paper 108 as shown in FIG. 16.

FIG. 16 illustrates that the carriage 100 reciprocating in the main-scanning direction forms an image having constant density on an entire area of the printing region 108a of the paper 108 being conveyed in the sub-scanning direction. In the printing region 108a of the paper 108, when the carriage 100 reciprocates and scans in the main-scanning direction and the recording head 118 discharges ink, images are successively formed in a region 119a11, a region 119b11, a region 119a12, a region 119b12, a region 119a13, and a region 119b13. In addition, the recording head 118 installed on the carriage 100 forms the image in each region while discharging the ink on the region where the image is already formed.

It is assumed that after the carriage 100 scans in the direction B and forms an image in the region 119b12, reception of next scan image data is delayed and a waiting time of the carriage 100 in the non-printing region becomes longer as compared with a case where other region is scanned. In this case, if the image is formed on the region 119b12 where drying of ink progresses in accordance with an extension of the waiting time, a difference of printing density occurs between the region 119b12 and other regions and density unevenness is formed as shown in FIG. 16.

In view of this, in the inkjet recording apparatus 1 according to the third embodiment, if the reception of the scan image data for forming an image in subsequent scanning is not complete, the control unit 120 extends the waiting time of the carriage 100 in the non-printing region to an extent such that the density unevenness is not generated.

By extending the waiting time of the carriage 100 in the non-printing region where necessary in this manner, it is possible to prevent a prolonged waiting time of the carriage 100 accompanied by the delayed reception of the scan image data and prevent generation of the density unevenness.

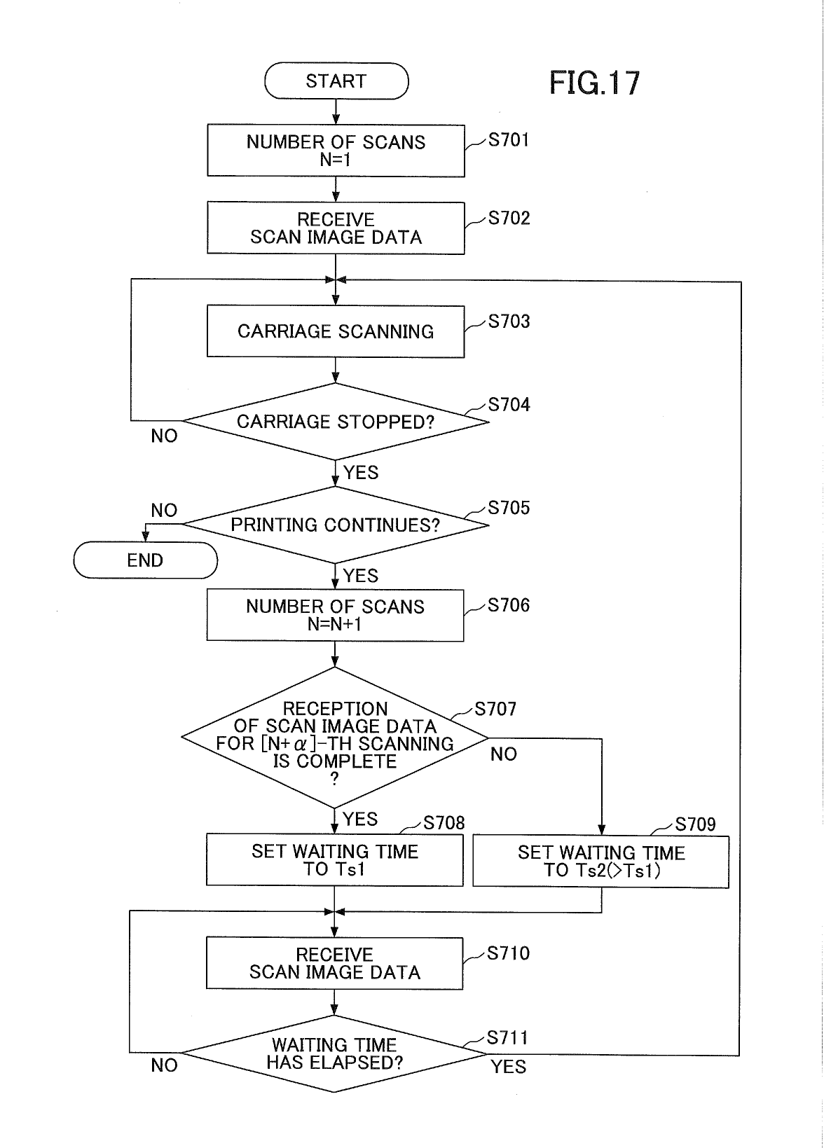

FIG. 17 is a flowchart of a print process in the third embodiment.

As shown in FIG. 17, when printing starts in the inkjet recording apparatus 1, in step S701, the control unit 120 starts counting a number of scans N from [N=1]. Next, in step S702, the host I/F 127 of the control unit 120 receives the scan image data from the printer driver of the PC connected to the inkjet recording apparatus 1.

In step S703, the carriage 100 starts scanning toward one end of the main-scanning direction and the recording head 118 forms an image by discharging ink based on the scan image data. The carriage 100 completes the scanning and stops in the non-printing region (step S704: YES). If printing is to be continuously performed (step S705: YES), in step S706, the control unit 120 counts the number of scans N (N=N+1).

Next, in step S707, the control unit 120 confirms whether reception of the scan image data to be used for an [N+α]-th scanning is complete. In this case, a is a natural number more than zero.

If α=1, for example, when the carriage 100 completes a first scanning (in the direction A shown in FIG. 16, for example) and starts a second scanning, the control unit 120 confirms whether reception of the scan image data to be used for a third (=2+1) scanning (in the direction B shown in FIG. 16, for example) is complete. Further, when the carriage 100 completes a fifth scanning and starts a sixth scanning, the control unit 120 confirms whether reception of the scan image data to be used for a seventh (=6+1) scanning is complete.

If α=3, for example, when the carriage 100 completes the first scanning and starts the second scanning, the control unit 120 confirms whether reception of the scan image data to be used for the fifth (=2+3) scanning is complete. Further, when the carriage 100 completes the fifth scanning and starts the sixth scanning, the control unit 120 confirms whether reception of the scan image data to be used for a ninth (=6+3) scanning is complete.

If reception of the scan image data to be used for the [N+α]-th scanning is complete (step S707: YES), in step S708, the control unit 120 sets the waiting time of the carriage 100 in the non-printing region to a waiting time Ts1.

If the reception of the scan image data to be used for the [N+α]-th scanning is not complete (step S707: NO), in step S709, the control unit 120 sets the waiting time of the carriage 100 in the non-printing region to a waiting time Ts2. In this case, the waiting time Ts2 is longer than the waiting time Ts1 and is set in advance within a time range such that density unevenness is not generated by dried ink when a solid image is to be formed.

In this manner, if the reception of the scan image data to be used for the [N+α]-th scanning is not complete, the control unit 120 extends the waiting time Is of the carriage 100 in the non-printing region. If the reception time of the scan image data is increased by extending the waiting time, it is possible to receive an increased amount of scan image data in the reception time and to prevent a delay of reception of the scan image data in subsequent scanning. Accordingly, in the subsequent scanning, it is possible to prevent extension of the waiting time of the carriage 100 in the non-printing region over a level where density unevenness is generated, the extension resulting from a delayed reception of the scan image data, and to prevent generation of the density unevenness.

In step S710, the host I/F 127 of the control unit 120 receives the scan image data until the waiting time Ts1 or the waiting time Ts2 that has been set has elapsed. If the waiting time Ts1 or the waiting time Ts2 has elapsed (step S711: YES), the process from step S703 is performed, so that the carriage 100 starts scanning and the recording head 118 discharges ink to form an image on the paper 108.

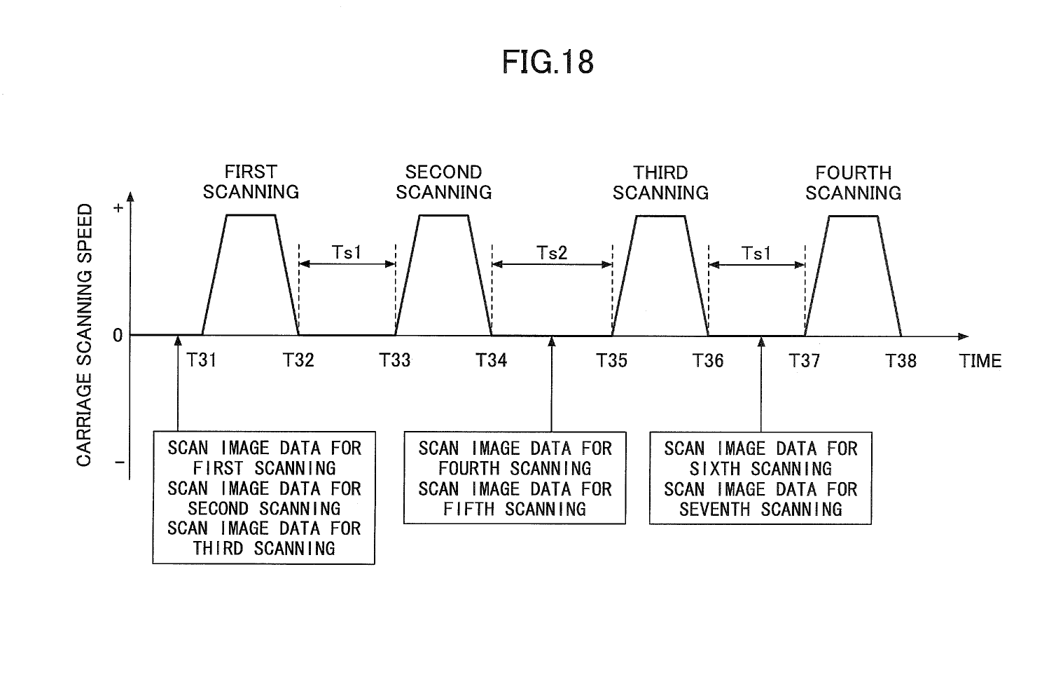

FIG. 18 is a diagram showing a print process (α=1) in the third embodiment.

In an example shown in FIG. 18, at a time T31 when the first scanning starts, reception of the scan image data to be used for image formation in the first to third scanning is complete. In this case, at a time when the first scanning is complete, the number of scans N is counted (N=1+1=2). Since the scan image data for the third (=2+1) scanning is received, the waiting time is set to the waiting time Ts1.

At a time T33 when the waiting time Ts1 has elapsed from a time T32 when the first scanning is complete, a second scanning starts. In the example shown in FIG. 18, during the waiting time Ts1 from the time T32 to the time T33, reception of the scan image data for a fourth scanning is not complete.

When the second scanning is complete at a time T34, the number of scans N is counted (N=2+1=3). Since the reception of the scan image data for the fourth (=3+1) scanning is not complete, the waiting time is set to the waiting time Ts2. In the example shown in FIG. 18, during the waiting time Ts2 from the time T34 to a time T35, reception of the scan image data for the fourth scanning and a fifth scanning is complete.

Next, at a time T35 when the waiting time Ts2 has elapsed from the time T34 when the second scanning is complete, the third scanning starts. When the third scanning is complete at a time T36, the number of scans N is counted (N=3+1=4). Since the reception of the scan image data for the fifth (=4+1) scanning is complete, the waiting time is set to the waiting time Ts1. In the example shown in FIG. 18, during the waiting time Ts1 from the time T36 to a time T37, reception of the scan image data for a sixth scanning and a seventh scanning is complete.

After the fourth scanning, the same process is repeatedly performed, in which number of scans N is counted when scanning is complete. If α=1, the waiting time is set to the waiting time Ts1 or the waiting time Ts2 based on whether reception of the scan image data for an [N+1]-th scanning is complete or not.

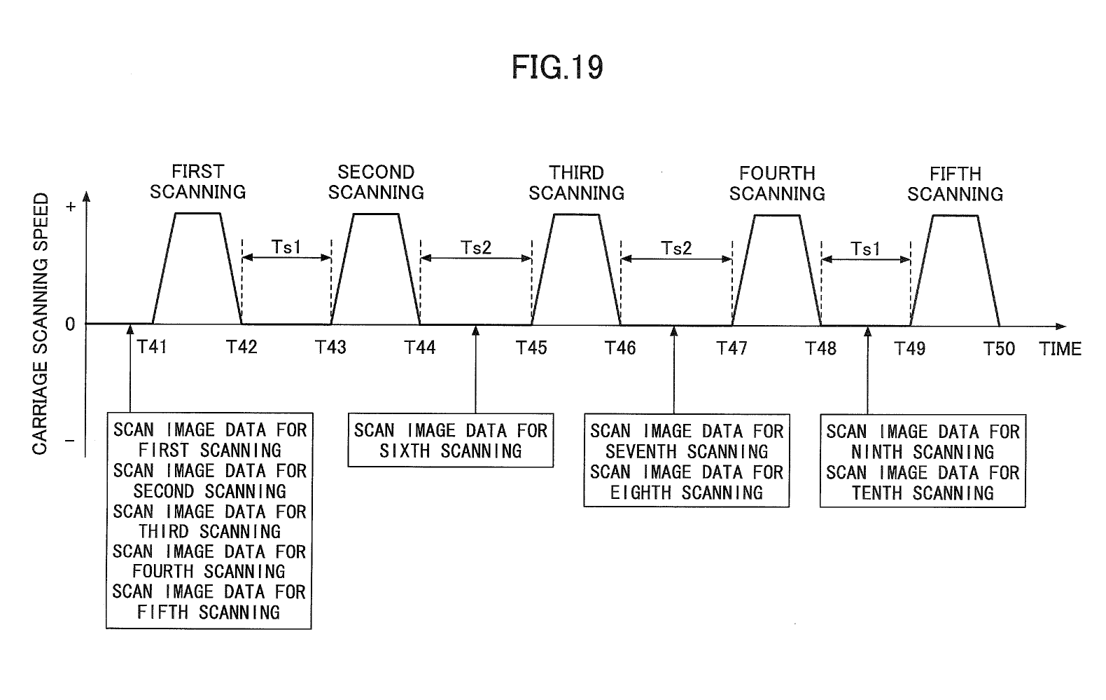

FIG. 19 is diagram showing a print process (α=3) in the third embodiment.

In an example shown in FIG. 19, first, at a time T41 when the first scanning starts, reception of the scan image data for the first scanning to the fifth scanning is complete. In this case, at a time T42 when the first scanning is complete, the number of scans N is counted (N=1+1=2). Since reception of the scan image data for the fifth (=2+3) scanning is complete, the waiting time is set to the waiting time Ts1.

At a time T43 when the waiting time Ts1 has elapsed from the time T42 when the first scanning is complete, a second scanning starts. In the example shown in FIG. 19, during the waiting time Ts1 from the time T42 to the time T43, reception of the scan image data for a sixth scanning is not complete.

When the second scanning is complete at a time T44, the number of scans N is counted (N=2+1=3). Since the reception of the scan image data for the sixth (=3+3) scanning is not complete, the waiting time is set to the waiting time Ts2. In the example shown in FIG. 19, during the waiting time Ts2 from the time T44 to a time T45, the reception of the scan image data for the sixth scanning is complete.

Next, at the time T45 when the waiting time Ts2 has elapsed from the time T44 when the second scanning is complete, the third scanning starts. When the third scanning is complete at a time T46, the number of scans N is counted (N=3+1=4). Since reception of the scan image data for the seventh (=4+3) scanning is not complete, the waiting time is set to the waiting time Ts2. In the example shown in FIG. 19, during the waiting time Ts2 from the time T46 to a time T47, reception of the scan image data for the seventh scanning and an eighth scanning is complete.

Next, at the time T47 when the waiting time Ts2 has elapsed from the time T46 when the third scanning is complete, a fourth scanning starts. When the fourth scanning is complete at a time T48, the number of scans N is counted (N=4+1=5). Since reception of the scan image data for the eighth (=5+3) scanning is complete, the waiting time is set to the waiting time Ts1. In the example shown in FIG. 19, during the waiting time Ts1 from the time T48 to a time T49, reception of the scan image data for the ninth scanning and a tenth scanning is complete.

The same process is repeatedly performed from the fifth scanning. When the scanning is complete, the number of scans N is counted. If α=3, the waiting time is set to the waiting time Ts1 or the waiting time Ts2 based on whether reception of the scan image data for an [N+3]-th scanning is complete or not.

As described above, in the inkjet recording apparatus 1 according to the third embodiment, if the reception of the scan image data to be used for image formation in subsequent scanning is not complete, the waiting time Is of the carriage 100 in the non-printing region is extended. By securing time to receive the scan image data before starting scanning, it is possible to prevent extension of the waiting time of the carriage 100 that results from a delayed reception of the scan image data in subsequent scanning and to prevent generation of density unevenness.

The image formation apparatus and the image formation method according to the embodiments are described above. However, the present invention is not limited to the above-mentioned embodiments but various types of modifications and improvements may be made within the scope of the present invention. The present invention is not limited to inkjet-type image formation apparatuses but may be applied to other image formation apparatuses that include a recording head that reciprocates and scans in a main-scanning direction relative to a recording medium being conveyed in a sub-scanning direction and forms an image on the recording medium.

Further, the present invention is not limited to these embodiments, and various variations and modifications may be made without departing from the scope of the present invention.

What is claimed is:

1. An image formation apparatus comprising:
a conveying unit that conveys a recording medium;
a recording head that reciprocates in a direction orthogonal to a conveying direction of the recording medium while the recording medium is being conveyed by the conveying unit, the recording head forming an image on the recording medium;
a reception unit that receives scan image data, the scan image data being used to form the image, while the recording head waits in a non-printing region of the recording medium; and
a control unit that controls a conveyance distance of the recording medium conveyed by the conveying unit while the recording head waits in the non-printing region, wherein the control of the conveyance distance of the recording medium is determined based on a scan image data reception period of the scan image data, the scan image data reception period being obtained from a communication speed of the reception unit.

2. The image formation apparatus as claimed in claim 1, wherein
the reception unit receives communication speed measurement data having a predetermined data size and receives a data size of the scan image data while the recording head reverses its movement direction in the non-printing region and
the control unit obtains the communication speed of the reception unit from a measurement data reception period of the communication speed measurement data and obtains the scan image data reception period from the data size of the scan image data and the communication speed.

3. The image formation apparatus as claimed in claim 1, wherein the control unit compares the scan image data reception period with a waiting period during which the recording head waits in the non-printing region, so that if the scan image data reception period is less than the waiting period, the control unit sets a conveying speed of the conveying unit to a first conveying speed, and if the scan image data reception period is not less than the waiting period, the control unit sets the conveying speed of the conveying unit to a second conveying speed lower than the first conveying speed.

4. The image formation apparatus as claimed in claim 2, wherein the control unit compares the scan image data reception period with a waiting period during which the recording head waits in the non-printing region, so that if the scan image data reception period is less than the waiting period, the control unit sets a conveying speed of the conveying unit to a first conveying speed, and if the scan image data reception period is not less than the waiting period, the control unit sets the conveying speed of the conveying unit to a second conveying speed lower than the first conveying speed.

5. The image formation apparatus as claimed in claim 1, wherein the control unit compares the scan image data reception period with a waiting period during which the recording head waits in the non-printing region, and if the scan image data reception period is not less than the waiting period, the control unit causes the conveying unit to stop conveying the recording medium after the recording medium is conveyed to a predetermined distance while the recording head waits in the non-printing region.

6. The image formation apparatus as claimed in claim 2, wherein the control unit compares the scan image data reception period with a waiting period during which the recording head waits in the non-printing region, and if the scan image data reception period is not less than the waiting period, the control unit causes the conveying unit to stop conveying the recording medium after the recording medium is conveyed to a predetermined distance while the recording head waits in the non-printing region.

7. The image formation apparatus as claimed in claim 1, further comprising:
a storage unit that stores a type of maintenance for the recording head and a maintenance period for each maintenance type, wherein
the control unit compares, if maintenance of the recording head is to be performed in the non-printing region when printing is performed on the recording medium, the maintenance period, the scan image data reception period, and a waiting period during which the recording head waits in the non-printing region, so that if the maintenance period is less than the scan image data reception period and the scan image data reception period is less than the waiting period, the control unit sets a conveying speed of the conveying unit to a first conveying speed, and if the maintenance period or the scan image data reception period is not less than the waiting period, the control unit sets the conveying speed of the conveying unit to a second conveying speed lower than the first conveying speed.

8. The image formation apparatus as claimed in claim 2, further comprising:
a storage unit that stores a type of maintenance for the recording head and a maintenance period for each maintenance type, wherein
the control unit compares, if maintenance of the recording head is to be performed in the non-printing region when printing is performed on the recording medium, the maintenance period, the scan image data reception period, and a waiting period during which the recording head waits in the non-printing region, so that if the maintenance period is less than the scan image data reception period and the scan image data reception period is less than the waiting period, the control unit sets a conveying speed of the conveying unit to a first conveying speed, and if the maintenance period or the scan image data reception period is not less than the waiting period, the control unit sets the conveying speed of the conveying unit to a second conveying speed lower than the first conveying speed.

9. An image formation method in an image formation apparatus, the image formation apparatus including a conveying unit that conveys a recording medium and a recording head that reciprocates in a direction orthogonal to a conveying direction of the recording medium while the recording medium is being conveyed by the conveying unit, the recording head forming an image on the recording medium, the image formation method comprising:
receiving scan image data, the scan image data being used to form the image, while the recording head waits in a non-printing region of the recording medium; and
controlling a conveyance distance of the recording medium conveyed by the conveying unit while the recording head waits in the non-printing region, the control of the conveyance distance of the recording medium the being determined based on a scan image data reception period of the scan image data.

10. A non-transitory computer-readable recording medium storing a computer-readable program that, when executed by a computer, causes the computer to perform the image formation method as claimed in claim 9.
